(19) United States
(12) Patent Application Publication
(10) Pub. No.: US 2020/0082379 A1
(43) Pub. Date: Mar. 12, 2020

(54) METHOD AND SYSTEM FOR CONDUCTING CUSTOMER DEVICE-BASED TRANSACTIONS AT TERMINAL DEVICES

(71) Applicant: Mastercard International Incorporated, Purchase, NY (US)

(72) Inventors: Piyush Sharma, Pune (IN); Navneet Jain, Pune (IN)

(21) Appl. No.: 16/551,273

(22) Filed: Aug. 26, 2019

(30) Foreign Application Priority Data
Sep. 6, 2018 (SG) 10201807655Q

(51) Int. Cl. G06Q 20/32; G06Q 20/18; G06F 9/451; G07F 19/00

(52) U.S. Cl. CPC G06Q 20/3223; G06Q 20/3221; G07F 19/206; G06F 9/452; G06Q 20/18

(57) ABSTRACT

A method includes conducting a transaction at an automated teller machine (ATM) or a point of sale (POS) device by using a customer device of a customer. The transaction involves rendering a payment interface of the ATM or the POS device on the customer device, such that the customer device serves as a mode of entry for transaction details of the transaction. The transaction is initiated at the ATM or the POS device based on the transaction details submitted by way of the payment interface rendered on the customer device. The method provides a degree of separation between the hardware of the ATM or the POS and the transaction.

### CROSS-REFERENCE TO RELATED APPLICATION

This application is a U.S. National Stage filing under 35 U.S.C. § 119, based on and claiming benefits of and priority to Singapore Patent Application No. 10201807655Q filed on Sep. 6, 2018. The entire disclosure of the above application is incorporated herein by reference for all purposes.

### FIELD OF THE INVENTION

The present invention relates to a method and a system for conducting electronic transactions, and, more particularly to a method and a system for conducting customer device-based transactions at terminal devices.

### BACKGROUND

Technological advancements have led to emergence and evolution of transaction systems that use card technologies for enabling customers to perform cashless transactions, such as deposits and withdrawals, credit transfers, purchase payments, and the like. The card technologies facilitate the cashless transactions by way of transaction cards, such as credit and debit cards. A cashless transaction at a terminal device (such as an automated teller machine (ATM) or a point-of-sale (POS) device) of the transaction system, typically, requires a customer to use her transaction card at the terminal device. The terminal device reads information from the transaction card to initiate a request for the transaction.

Such transaction systems, as they stand, face multiple shortcomings. For example, installation of the ATM is hardware intensive, involving high expenditure in regards to encrypted pin pad (EPP), function defined keys (FDKs), and the like. Failure of a single hardware component may lead to the ATM being out of service. This often results in hours, and often days, of downtime of the ATM, causing distress to the customers and requiring deployment of manpower and financial resources, by an acquirer, to address the issue(s). In addition to this, a customer is susceptible to frauds by skimmers, devices that are programmed to steal the card information from ATMs, and by bystanders, who may note a password of the transaction card used by the customer to authenticate fraudulent transactions. Frauds occurring at ATMs have created a need to isolate hardware of the ATMs from the transactions. Further, a customer making a purchase from a merchant by using a transaction card at a POS device of the merchant, is often unaware of an amount entered by the merchant in the POS device. The merchant may, intentionally or unintentionally, enter an amount significantly higher than what is due. A naive customer may proceed to pay the merchant the incorrect amount without realizing the error until much later. It is evident that transactions at POS devices, currently, are merchant driven and pose risks to uninformed customers.

In light of the foregoing, there exists a need for a solution that, in the interest of customers, establishes a degree of isolation between the hardware of terminal devices and the transactions, and provides a more secure environment to the customers for carrying out the transactions.

### SUMMARY

In an embodiment of the present invention, a method for conducting transactions is provided. The method includes receiving, by a server from a customer device of a customer, a first request to initiate a transaction at a terminal device by using the customer device. Based on the first request, the server enters a listening mode. A second request is received by the server from the terminal device, while the server is in the listening mode. The second request includes at least first identification information of the customer and second identification information of the terminal device. Following the reception of the second request, a graphical user interface (GUI) is rendered to initiate a transaction session on the customer device by the server for facilitating the transaction. The transaction is initiated at the terminal device by the server based on transaction details provided by the customer during the transaction session using the GUI.

In another embodiment of the present invention, a system for conducting transactions is provided. The system includes circuitry that is configured to receive a first request, from a customer device of a customer, to initiate a transaction at a terminal device by using the customer device. The server enters a listening mode based on the first request. The circuitry receives a second request from the terminal device, while the server is in the listening mode. The second request includes at least first identification information of the customer and second identification information of the terminal device. Following the reception of the second request, the circuitry renders a GUI to initiate a transaction session on the customer device for facilitating the transaction. The circuitry initiates the transaction at the terminal device based on transaction details submitted by the customer during the transaction session using the GUI.

In yet another embodiment of the present invention, a method for conducting transactions is provided. The method includes presenting, by a server on a customer device of a customer, one or more options to initiate a customer device-based transaction at a terminal device. The one or more options are selectable by the customer. A first request is received by the server from the customer device to initiate the customer device-based transaction at the terminal device, when the customer selects one of the one or more options. Based on the first request, the server enters a listening mode. A second request is received by the server from the terminal device, while the server is in the listening mode. The second request includes at least first identification information of the customer and second identification information of the terminal device. Following the reception of the second request, a payment interface of the terminal device is rendered by the server to initiate a transaction session on the customer device, such that the transaction is initiated at the terminal device based on transaction details submitted by the customer using the payment interface during the transaction session.

### BRIEF DESCRIPTION OF THE DRAWINGS

Various embodiments of the present invention are illustrated by way of example, and not limited by the appended figures, in which like references indicate similar elements, and in which:

FIG. 1 is a block diagram that illustrates an environment for conducting transactions, in accordance with an embodiment of the present invention;

FIG. 2A is a block diagram of an issuer server of the environment of FIG. 1 that enables a customer to perform transactions at a terminal device by using a customer device, in accordance with an embodiment of the present invention;

FIG. 2B is a block diagram that illustrates a payment network server of the environment of FIG. 1 that enables a customer to perform transactions at a terminal device by using a customer device, in accordance with an embodiment of the present invention;

FIG. 3 is an exemplary scenario that illustrates user interface (UI) screens that are rendered on the customer device of FIG. 1 for enabling the customer to perform a customer device-based transaction, in accordance with an embodiment of the present invention;

FIG. 4A is an exemplary scenario that illustrates the terminal device of FIG. 1, in accordance with an embodiment of the present invention;

FIG. 4B is an exemplary scenario that illustrates the terminal device of FIG. 1, in accordance with another embodiment of the present invention;

FIG. 5A represents an exemplary scenario that illustrates various UI screens that are rendered on the customer device of FIG. 1 for facilitating a customer device-based transaction, in accordance with an embodiment of the present invention;

FIG. 5B represents an exemplary scenario that illustrates various UI screens that are rendered on the customer device for facilitating the customer device-based transaction, in accordance with an embodiment of the present invention;

FIG. 6A is a process flow diagram that illustrates an exemplary scenario for conducting a customer device-based transaction at the terminal device by way of the customer device of FIG. 1, in accordance with an embodiment of the present invention;

FIG. 6B is a process flow diagram that illustrates an exemplary scenario for conducting a customer device-based transaction at the terminal device by way of the customer device of FIG. 1, in accordance with another embodiment of the present invention;

FIG. 7A is a process flow diagram that illustrates an exemplary scenario for conducting a customer device-based transaction at the terminal device by way of the customer device of FIG. 1, in accordance with yet another embodiment of the present invention;

FIG. 7B is a process flow diagram that illustrates an exemplary scenario for conducting a customer device-based transaction at the terminal device by way of the customer device of FIG. 1, in accordance with yet another embodiment of the present invention;

FIG. 8 represents a flow chart that illustrates a method for conducting a customer device-based transaction at the terminal device of FIG. 1, in accordance with an embodiment of the present invention;

FIG. 9 represents a high-level flow chart that illustrates a method for conducting a customer device-based transaction at the terminal device of FIG. 1, in accordance with an embodiment of the present invention;

FIG. 10 represents a high-level flow chart that illustrates a method for conducting a customer device-based transaction at the terminal device of FIG. 1, in accordance with another embodiment of the present invention; and

FIG. 11 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

A customer may approach a terminal device (such as an automated teller machine (ATM) or a point-of-sale (POS) device) for performing a transaction. For example, the customer may wish to withdraw cash at an ATM or make a payment at a merchant store by way of a POS device. In one exemplary scenario, the terminal device may have a faulty keypad, thereby causing inconvenience to the customer while she enters transaction details of the transaction at the terminal device. In another exemplary scenario, the customer may be at a risk of disclosing confidential information of her transaction card to a bystander, while she enters the transaction details of the transaction at the terminal device.

Various embodiments of the present invention provide a method and a system that solve the above-mentioned problems by enabling the customer to use her customer device, such as a mobile phone, as a mode of entry for the transaction details. The customer, at terminal device, accesses an application (such as a mobile application or a web application), hosted by a server, by using the customer device to initiate a first request. By initiating the first request, the customer seeks a permission from the server to use the customer device as the mode of entry for the transaction details. The server receives the first request and enters a listening mode, in anticipation of a second request from the terminal device. The customer provides her identification information, such as a registered mobile number, to the terminal device. The terminal device then transmits the second request to the server. The second request includes the identification information provided by the customer and identification information of the terminal device, such as an ATM ID or a POS device ID. The server verifies the identification information of the customer and the identification information of the terminal device. On successful verification, the server creates a transaction session on the customer device by rendering a payment interface of the terminal device on the customer device. The customer uses the rendered payment interface to enter the transaction details (such as a transaction amount, debit card or credit card details, or the like) of the transaction. Based on the transaction details entered by the customer by using the payment interface, the transaction is authorized. On successful authorization, the transaction is carried out at the terminal device. For example, the ATM dispenses a cash equivalent to the transaction amount. Similarly, the POS device prints an invoice or a receipt indicating a success of the transaction. The server may be associated with an issuer of the customer or a payment network.

Thus, the method and system of the present invention provides a secure environment to the customer for performing transactions at terminal devices by using the customer device as the mode of entry for the transaction details. Hence, a degree of isolation is established between the mode of entry for the transaction details and the transaction, which makes the transaction more customer driven and reduces the chances of fraud by skimmers and bystanders.

### Terms Description (in Addition to Plain and Dictionary Meaning)

Transaction is an exchange of funds between two or more parties. For example, a transaction may include transferring a transaction amount from a bank account of a customer to a bank account of a merchant, when the customer makes a purchase from the merchant. In another example, the transaction may include dispensing cash, at an ATM, equivalent to a transaction amount debited from the bank account of the customer, based on a request from the customer.

Identification information of a customer refers to details of the customer that uniquely identifies the customer. For example, the identification information of the customer may be a registered mobile number, a registered e-mail ID of the customer, or a combination thereof.

Identification information of a terminal device refers to details that uniquely identify the terminal device. For example, the identification information of the terminal device may include an ATM ID, a POS device ID, and the like.

Transaction card is a payment device, such as a debit card, a credit card, a prepaid card, a promotional card, a contactless card, and/or other devices, that holds identification information of a customer account of a customer. The transaction card can be used to perform transactions, such as deposits and withdrawals, credit transfers, purchase payments, and the like, from the corresponding customer account. In an embodiment, the transaction card may be radio frequency identification (RFID) or near field communication (NFC) enabled for performing contactless payments.

Merchant is an entity that offers various products and/or services in exchange for payments. The merchant may establish a merchant account with a financial institution, such as a bank (hereinafter, “acquirer”) to accept the payments from several customers by use of one or more payment methods. The merchant may accept payments by means of cash or cashless transactions. In a cashless transaction, the merchant uses a POS device for receiving a payment from a customer.

Issuer is a financial institution, where customer accounts of several customers are established and maintained. The issuer ensures payment for authorized transactions in accordance with various payment network regulations and local legislation.

Payment network is a transaction card association that acts as an intermediate entity between acquirers and issuers to authorize and fund transactions. Examples of payment networks include MasterCard®, American Express®, VISA®, Discover®, Diners Club®, and the like. The payment network settles the transactions between various acquirers and issuers, when transaction cards are used for initiating transactions.

A server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of a payment network server, an issuer server, an acquirer server, or a merchant server.

First request refers to a request by which a customer seeks permission from a server to use her customer device as a mode of entry for transaction details of a transaction that is to be performed at a terminal device. The server is one of an issuer server or a payment network server.

Listening mode is a mode of an issuer server or a payment network server, in which the issuer server or the payment server waits in anticipation of a second request from a terminal device. In one embodiment, the listening mode is triggered at the reception of a first request from a customer device of a customer. The issuer server or the payment server may enter the listening mode for a finite time-interval.

Second request is a request from a terminal device by which identification information of a customer and a terminal device is communicated to an issuer or a payment network. The second request is one of a broadcast message or directed message to be received by a server (such as an issuer server or a payment network server) while in the listening mode.

Graphical user interface (GUI) is a user interface that includes windows, icons, text boxes, and/or other interactive features to receive inputs from customers, provide information, or display output to the customers. A GUI of a terminal device is rendered on a customer device to replicate functionality of a payment interface of the terminal device. The GUI enables the customer device to serve as a mode of entry for transaction details of a transaction that the customer wants to perform at the terminal device.

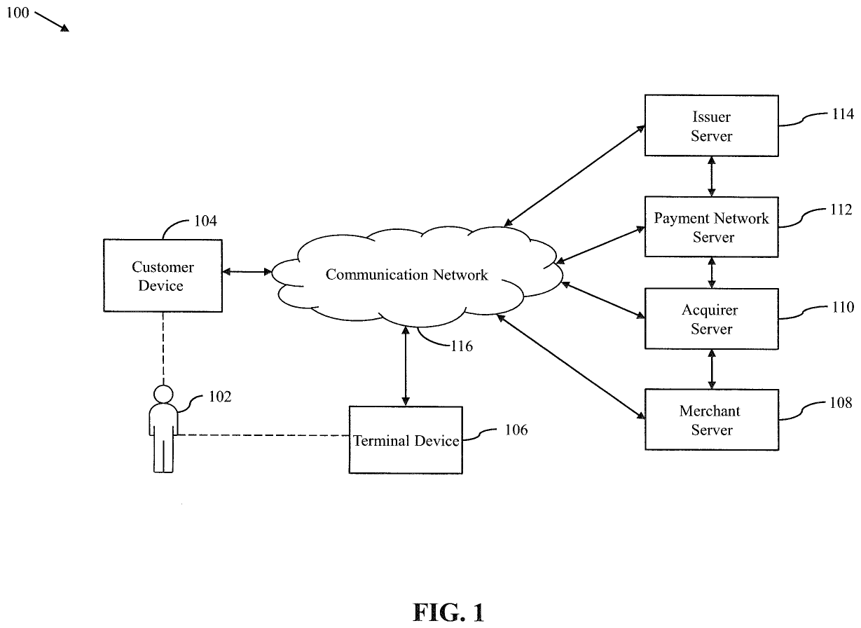

FIG. 1 is a block diagram that illustrates an exemplary environment 100 for conducting transactions, in accordance with an embodiment of the present invention. The environment 100 includes a customer 102 in possession of a customer device 104. The environment 100 further includes a terminal device 106, a merchant server 108, an acquirer server 110, a payment network server 112, and an issuer server 114. The customer device 104, the terminal device 106, the merchant server 108, the acquirer server 110, the payment network server 112, and the issuer server 114 may communicate with each other by way of a communication network 116 or through separate communication networks established therebetween.

The customer 102 is an individual, who is an account holder of a customer account. The customer account is an account maintained at a financial institution, such as an issuer. The customer account may be linked to a mobile number and an electronic mail (e-mail) ID of the customer 102, as part of a customer registration procedure (such as a know-your-customer procedure, i.e., KYC) performed by the issuer. The customer 102 may be in possession of a transaction card (not shown) that is linked to the customer account and stores information of the customer account (hereinafter referred to as “account information”). The account information may be stored in an electronic chip or a machine readable magnetic strip embedded in the transaction card. The account information may include an account number, a name of an account holder (i.e., the customer 102), or the like. The transaction card, commonly, has a unique card number, an expiry date, a card security code, and a card type associated to it. The card number, the expiry date, the card security code, and the card type constitute transaction card details of the transaction card. The customer 102 may perform various transactions from the customer account by using the transaction card. In one embodiment, the transaction card is a physical card. In another embodiment, the transaction card is a virtual card that is stored in a memory (not shown) of the customer device 104. Examples of the transaction card include a credit card, a debit card, a charge card, a prepaid card, a gift card, an electronic cash card, or the like.

The customer device 104 is a communication device of the customer 102. The customer 102 uses the customer device 104 for accessing a transaction application (for example, a mobile application or a web application) that enables the customer 102 to perform a transaction at the terminal device 106 by using the customer device 104 as a mode of entry for transaction details of the transaction. The transaction details include a type of transaction, a type of customer account, and a transaction amount. Examples of the type of transaction include a cash withdrawal at an ATM, a payment at a POS device, a deposit at an ATM, or the like. Examples of the type of customer account may include a savings account, a current account, or the like. A transaction that is performed at the terminal device 106 by using the customer device 104 as the mode of entry for the transaction details is hereinafter referred to as a customer device-based transaction. In one embodiment, the transaction application may be installed in the memory of the customer device 104. In another embodiment, the transaction application may be accessed by way of a browser installed in the memory of the customer device 104. Examples of the customer device 104 include, but are not limited to, a mobile phone, a smartphone, a laptop, a tablet, a phablet, or any other communication device. The customer device 104 is further linked to the mobile number and the e-mail ID of the customer 102 that are linked to the customer account as part of the customer registration procedure performed by the issuer. The mobile number and/or the e-mail ID of the customer 102 constitute first identification information of the customer 102.

The terminal device 106 is an electronic device that enables the customer 102 to perform various transactions from the customer account by using the transaction card or the customer device 104. The terminal device 106 is installed by an acquirer. The terminal device 106 has unique identification information (hereinafter referred to as “second identification information”) associated therewith. The second identification information may include a numerical code, alpha-numeric code, a QR code, or the like, which uniquely identifies the terminal device 106. For example, when the terminal device 106 is an ATM, the second identification information is an ATM ID, and when the terminal device 106 is a POS device, the second identification information is a POS device ID. The terminal device 106 presents a payment interface to the customer 102 for enabling the customer 102 to perform transactions from the customer account. The payment interface may present various transaction options that are selectable by the customer 102 for performing the transactions. For example, the payment interface may present a first transaction option that enables the customer 102 to perform a customer device-based transaction at the terminal device 106 by using the customer device 104. Examples of the terminal device 106 include an ATM, a POS device, a point-of-interaction (POI) device, a point-of-purchase (POP) device, or the like.

The merchant server 108 is a computing server that is associated with a merchant (not shown). The merchant may establish a merchant account with another financial institution, such as an acquirer, to accept payments for products and/or services purchased and/or availed by various customers from the merchant. In one embodiment, the merchant may possess the terminal device 106 which is a POS device, a POP device, or a POI device. The merchant server 108 processes the transactions that are performed, at the terminal device 106, by various customers for making purchases from the merchant. The merchant server 108 further maintains a purchase history of each customer who makes a purchase from the merchant. For example, the purchase history of the customer 102 maintained by the merchant server 108 represents details of all previous purchases made by the customer 102 from the merchant. The details of a purchase may include a purchase order ID, a transaction amount for the purchase, a purchase date, a purchase time, or the like. The purchase order ID is unique identifier assigned to each purchase. The transaction amount represents the amount paid by the customer 102 for making the purchase.

The acquirer server 110 is a computing server that is associated with the acquirer. The acquirer uses the acquirer server 110 to process transaction requests received from various terminal devices, such as the terminal device 106, associated therewith. The acquirer server 110 further communicates the transaction requests to payment networks or issuers, by way of the communication network 116. Based on the transaction requests, the acquirer server 110 credits or debits corresponding merchant accounts of various merchants that are established with the acquirer.

The payment network server 112 is a computing server that represents an intermediate entity between the acquirer server 110 and the issuer server 114 for authorizing and funding the transactions performed by using the transaction cards. Examples of various payment networks include MasterCard, American Express, VISA, Discover, Diners Club, or the like.

The issuer server 114 is a computing server that is associated with the issuer. The issuer is a financial institution that manages customer accounts of multiple customers. Account details of the customer accounts established with the issuer are stored as account profiles in a memory of the issuer server 114 or on a cloud server associated with the issuer server 114. The account details may include an account balance, a credit line, details of an account holder, a transaction history of the account holder, account information, or the like. The details of the account holder are obtained as a part of the customer registration procedure performed by the issuer and include name, age, gender, physical attributes, registered mobile number, alternate mobile number, registered e-mail ID, an address, or the like of the account holder. Based on the transaction requests, the issuer server 114 credits and debits the corresponding customer accounts. Methods for crediting and debiting customer accounts via the issuer server 114 will be apparent to persons having skill in the art and may include processing via the traditional four-party system or the traditional three-party system.

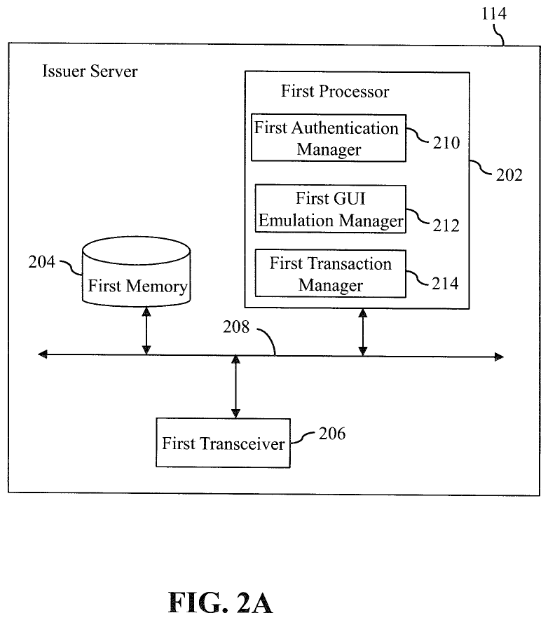

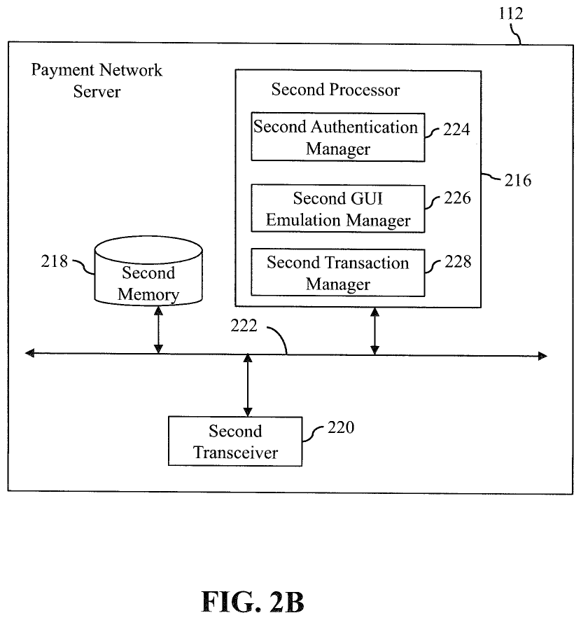

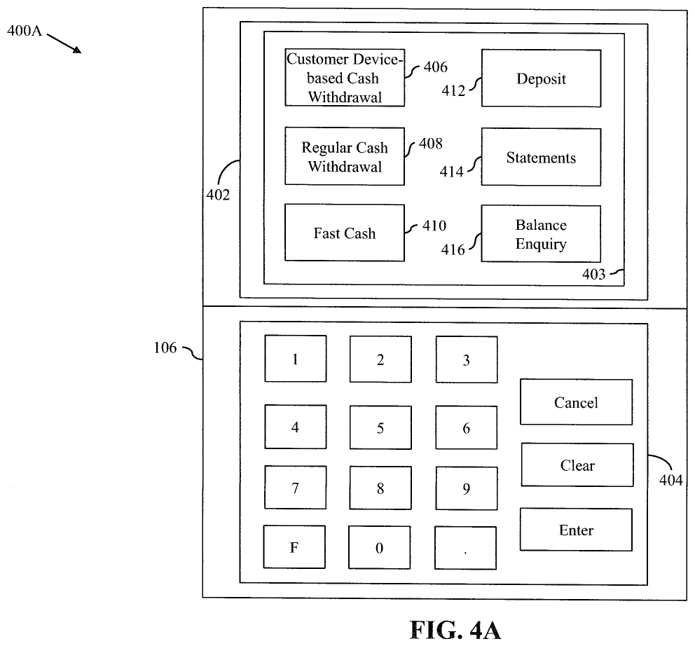

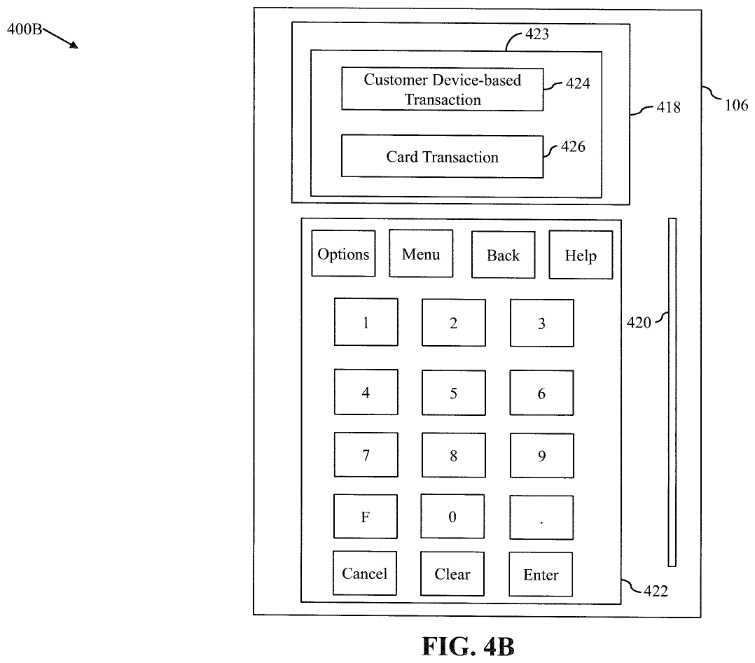

The issuer server 114 hosts the transaction application that enables the customer 102 to perform customer device-based transactions at the terminal device 106. The customer 102 may access the transaction application to request the issuer server 114 to allow her to perform the transaction at the terminal device 106 by way of the customer device 104. Based on the request of the customer 102, the issuer server 114 enters a listening mode for a first time-interval in anticipation of another request from the terminal device 106 at which the customer 102 wants to perform the transaction. In a scenario, when the issuer server 114 receives the request from the terminal device 106 within the first time-interval, the issuer server 114 initiates a transaction session on the customer device 104. During the transaction session, the issuer server 114 renders a payment interface (as shown in FIG. 4A) of the terminal device 106 on the customer device 104. The payment interface replicates functionalities of the terminal device 106 on the customer device 104, thereby allowing the customer 102 to submit the transaction details of the transaction. Based on the transaction details submitted by the customer 102, the transaction is performed at the terminal device 106. Various components of the issuer server 114 are explained in detail in conjunction with FIG. 2A.

In another embodiment, the payment network server 112 is also capable of hosting the transaction application that enables the customer 102 to use the customer device 104 as the mode of entry for providing the transaction details, without deviating from the scope of the invention. Various components of the payment network server 112 that enable this embodiment are explained in detail in conjunction with FIG. 2B.

Examples of the merchant server 108, the acquirer server 110, the payment network server 112, and the issuer server 114 include, but are not limited to, computers, laptops, mini-computers, mainframe computers, any non-transient and tangible machines that can execute a machine-readable code, cloud-based servers, distributed server networks, a network of computer systems, or a combination thereof.

The communication network 116 is a medium through which content and messages are transmitted between the customer device 104, the merchant server 108, the acquirer server 110, the payment network server 112, the issuer server 114, and other entities that are pursuant to one or more standards for the interchange of transaction messages, such as the ISO8583 standard. Examples of the communication network 116 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 116 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

FIG. 2A is a block diagram of the issuer server 114 that enables the customer 102 to perform transactions at the terminal device 106 by using the customer device 104, in accordance with an embodiment of the present invention. The issuer server 114 includes a first processor 202, a first memory 204, and a first transceiver 206. The first processor 202, the first memory 204, and the first transceiver 206 communicate with each other by way of a first communication bus 208. The first processor 202 includes a first authentication manager 210, a first GUI emulation manager 212, and a first transaction manager 214.

The first processor 202 includes suitable logic, circuitry, and/or interfaces to process transactions performed by the customer 102. In one embodiment, the first processor 202 hosts the transaction application using which the customer device 104 interacts with the issuer server 114. The transaction application offers a platform that enables the customer 102 to use the customer device 104 as a mode of entry for providing transaction details for a transaction which the customer 102 wants to perform at the terminal device 106. In one embodiment, the first processor 202 receives a first request from the customer 102 seeking permission for using the customer device 104 as the mode of entry for providing the transaction details. Based on the first request, the first processor 202 instructs the first transceiver 206 to enter a listening mode for a first time-interval in anticipation of a second request from the terminal device 106 at which the customer 102 wants to perform the transaction. When the second request including the first and second identification information is received from the terminal device 106, the first processor 202 renders the payment interface of the terminal device 106 on the customer device 104. The first processor 202 further processes the transaction for approval or denial based on the transaction details submitted by the customer 102 using the rendered payment interface. Examples of the first processor 202 include, but are not limited to, an application-specific integrated circuit (ASIC) processor, a reduced instruction set computing (RISC) processor, a complex instruction set computing (CISC) processor, a field-programmable gate array (FPGA), and the like. The first processor 202 executes the operations for processing the transactions by way of the first authentication manager 210, the first GUI emulation manager 212, and the first transaction manager 214.

The first authentication manager 210 includes suitable logic, circuitry, and/or interfaces for authorizing transactions and authenticating customers (such as the customer 102) who perform the transactions. The customer 102 may attempt to login to the transaction application by providing a username and a password. The first authentication manager 210 verifies whether the username and password provided by the customer 102 are valid. In a scenario where the username and password provided by the customer 102 are valid, the customer 102 is logged into the transaction application. When the second request is received by the issuer server 114, the first authentication manager 210 verifies the validity of the first and second identification information included in the second request. The first authentication manager 210 validates the first and second identification information by using various data validation and verification techniques known in the art. The first GUI emulation manager 212 includes suitable logic, circuitry, and/or interfaces for rendering the payment interface of the terminal device 106 on the customer device 104. The rendered payment interface is responsive to commands from the customer 102 and enables the customer 102 to submit transaction details for the transaction that the customer 102 wants to perform at the terminal device 106. The first transaction manager 214 includes suitable logic, circuitry, and/or interfaces for crediting or debiting customer accounts established with the issuer based on corresponding transaction requests.

The first memory 204 includes suitable logic, circuitry, and/or interfaces to store account profiles for the customer accounts that are maintained at the issuer. The first memory 204 further stores a set of instructions or a software code for a latest version of the payment interface of the terminal device 106 and the transaction application. Examples of the first memory 204 include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the first memory 204 in the issuer server 114, as described herein. In another embodiment, the first memory 204 may be realized in form of a database server or a cloud storage working in conjunction with the issuer server 114, without departing from the scope of the invention.

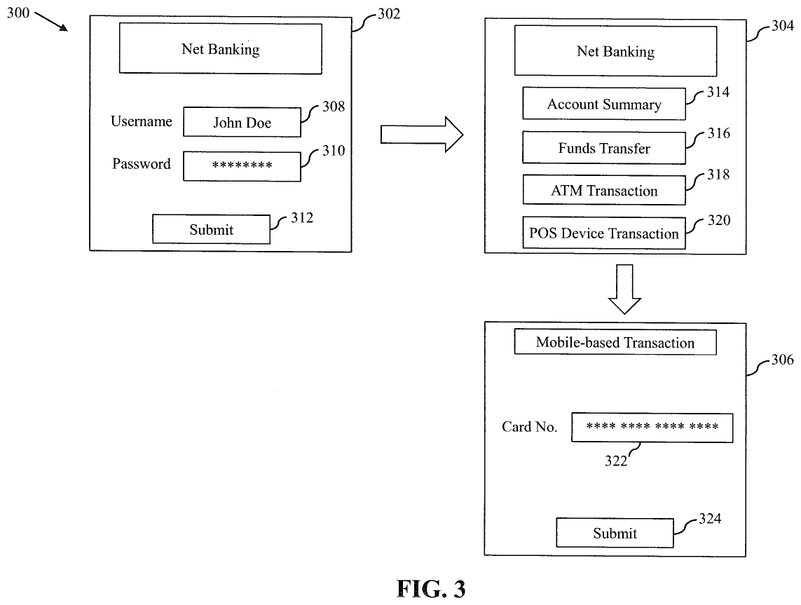

The first transceiver 206 transmits and receives data over the communication network 116 using one or more communication protocols. The first transceiver 206 transmits/receives various requests and messages to/from the customer device 104, the terminal device 106, the merchant server 108, the acquirer server 110, the payment network server 112, or other entities that are pursuant to one or more standards for the interchange of transaction messages, such as the ISO8583 standard. The first transceiver 206 may enter the listening mode for the first time-interval based on the first request received from the customer device 104. Examples of the first transceiver 206 include, but are not limited to, an antenna, a radio frequency transceiver, a wireless transceiver, a Bluetooth transceiver, an ethernet port, a universal serial bus (USB) port, or any other device configured to transmit and receive data. The functions performed by the issuer server 114 are explained later in conjunction with FIGS. 3, 4A, 4B, 5A and 5B, and 6A and 6B.

FIG. 2B is a block diagram that illustrates the payment network server 112 that enables the customer 102 to perform transactions at the terminal device 106 by using the customer device 104, in accordance with an embodiment of the present invention. The payment network server 112 includes a second processor 216, a second memory 218, and a second transceiver 220. The second processor 216, the second memory 218, and the second transceiver 220 communicate with each other by way of a second communication bus 222. The second processor 216 includes a second authentication manager 224, a second GUI emulation manager 226, and a second transaction manager 228.

The second processor 216 includes suitable logic, circuitry, and/or interfaces to process transactions performed by the customer 102. In another embodiment, the second processor 216, instead of the first processor 202, may host the transaction application. The transaction application enables the customer 102 to use the customer device 104 as the mode of entry for providing the transaction details. The second processor 216 renders the payment interface of the terminal device 106 on the customer device 104, when the second processor 216 receives the first request from the customer device 104 and the second request from the terminal device 106. The second processor 216 receives the transaction details submitted by the customer 102 by way of the rendered payment interface and communicates the transaction details to the issuer server 114 for further processing of the transaction. Examples of the second processor 216 include, but are not limited to, an ASIC processor, a RISC processor, a CISC processor, an FPGA, and the like. The second processor 216 executes the operations for processing the transactions by way of the second authentication manager 224, the second GUI emulation manager 226, and the second transaction manager 228.

The second authentication manager 224 includes suitable logic, circuitry, and/or interfaces for authorizing transactions and authenticating the customers (such as the customer 102) who perform the transactions. The second authentication manager 224 ensures that the customer 102 has provided a valid username and password for logging into the transaction application. Upon receiving the second request from the terminal device 106, the second authentication manager 224 verifies the validity of the first and second identification information included in the second request. The second authentication manager 224 validates the first and second identification information, using various data validation and verification techniques known in the art.

The second GUI emulation manager 226 includes suitable logic, circuitry, and/or interfaces for rendering the payment interface of the terminal device 106 on the customer device 104. The second transaction manager 228 includes suitable logic, circuitry, and/or interfaces to identify an issuer that corresponds to a transaction request and transmit the transaction request to an issuer server of the identified issuer for crediting or debiting customer account that corresponds to the transaction request.

The second memory 218 includes suitable logic, circuitry, and/or interfaces to store customer profiles of customers who have signed up for the transaction application hosted by the payment network server 112. The second memory 218 further stores a set of instructions or a software code for a latest version of the payment interface of the terminal device 106 and the transaction application. Examples of the second memory 218 include a RAM, a ROM, a removable storage drive, an HDD, a flash memory, a solid-state memory, and the like. It will be apparent to a person skilled in the art that the scope of the invention is not limited to realizing the second memory 218 in the payment network server 112, as described herein. In another embodiment, the second memory 218 may be realized in form of a database server or a cloud storage working in conjunction with the payment network server 112, without departing from the scope of the invention.

The second transceiver 220 transmits and receives data over the communication network 116 using one or more communication protocols. The second transceiver 220 transmits/receives various requests and messages to/from the customer device 104, the terminal device 106, the merchant server 108, the acquirer server 110, the issuer server 114, or other entities that are pursuant to one or more standards for the interchange of transaction messages, such as the ISO8583 standard. Examples of the second transceiver 220 include, but are not limited to, an antenna, a radio frequency transceiver, a wireless transceiver, a Bluetooth transceiver, an ethernet port, a USB port, or any other device configured to transmit and receive data. The functions performed by the payment network server 112 are explained later in conjunction with FIGS. 3, 4A and 4B, 5A and 5B, and 7A and 7B.

FIG. 3 is an exemplary scenario 300 that illustrates first through third user interface (UI) screens 302, 304, and 306 that are rendered on the customer device 104 for enabling the customer 102 to perform a customer device-based transaction, in accordance with an embodiment of the present invention. The UI screens 302, 304, and 306 correspond to the transaction application and for the ongoing description, it is assumed that the transaction application is hosted by the issuer server 114. The customer 102 is a registered customer of the issuer, who signs up for the transaction application using a username and a password. The issuer server 114 stores the username and password of the customer 102 in the account profile of the customer 102 that is stored in the first memory 204. The first memory 204 further stores the registered mobile number and the e-mail ID of the customer 102. The registered mobile number and the e-mail ID are provided by the customer 102 to the issuer as a part of the customer registration procedure performed by the issuer. The registered mobile number and the e-mail ID of the customer 102 stored in the first memory 204 constitute the first identification information of the customer 102.

The customer 102 approaches the terminal device 106 and opens the transaction application (such as a banking application) of the issuer on the customer device 104. When the customer 102 opens the transaction application, the UI screen 302 is displayed on a display (not shown) of the customer device 104. The UI screen 302 is an interactive interface of the transaction application that presents first and second text boxes 308 and 310 in which the customer 102 can enter her username and password, respectively. The UI screen 302 further presents a first submit button 312, which is selectable by the customer 102. The customer 102 enters her username and password in the first and second text boxes 308 and 310, respectively, and selects the first submit button 312. The transaction application serves as a gateway to the issuer server 114, and therefore the username and password entered by the customer 102 are communicated to the issuer server 114.

The first transceiver 206 receives the username and password entered by the customer 102. The first authentication manager 210 verifies the username and password entered by the customer 102 against the username and password of the customer 102 stored in the first memory 204. The first authentication manager 210 authenticates the customer 102 when the username and password entered by the customer 102 matches the username and password stored in the first memory 204. Upon successful authentication, the customer 102 is allowed access to the transaction application and redirected from the UI screen 302 to the UI screen 304.

The UI screen 304 presents a first set of transaction options (such as an account summary option 314, a funds transfer option 316, an ATM transaction option 318, a POS device transaction option 320, or the like). The transaction options in the first set of transaction options are selectable by the customer 102. The ATM transaction option 318 and the POS device transaction option 320 enable the customer 102 to perform the customer device-based transaction at an ATM or a POS device, respectively. The customer 102 may choose, depending on whether the terminal device 106 is an ATM or a POS device, one of the ATM transaction option 318 or the POS device transaction option 320, respectively, to engage in the customer device-based transaction at the terminal device 106. The selection of one of the ATM transaction option 318 or the POS device transaction option 320 corresponds to the first request.

The customer 102 is redirected from the UI screen 304 to the UI screen 306, when the customer 102 chooses to engage in the customer device-based transaction by selecting one of the ATM transaction option 318 or the POS device transaction option 320. The UI screen 306 presents a third text box 322, which allows the customer 102 to enter a card number of the transaction card that the customer 102 wants to use for performing the customer device-based transaction. In another embodiment, the UI screen 306 may present a list of transaction cards associated with the customer account, allowing the customer 102 to choose a transaction card from the list of transaction cards. In the current scenario, the UI screen 306 may include a section (not shown) that requires the customer 102 to provide transaction card details, such as the card security code, a personal identification number (PIN), and the like, of the selected transaction card. The UI screen 306 further presents a second submit button 324 that is selectable by the customer 102. When the customer 102 selects the second submit button 324, the first transceiver 206 receives an encrypted version of the transaction card details entered by the customer 102 in the third text box 322. The first authentication manager 210 verifies whether the transaction card details entered by the customer 102 in the third text box 322 match the transaction card details of the customer 102 stored in the account profile of the customer 102. Upon successful verification, the issuer server 114 enters a listening mode, for the first time-interval, in anticipation of a message to be received from the terminal device 106 at which the customer 102 wants to perform the customer device-based transaction.

It will be apparent to a person having ordinary skill in the art that the UI screens 302, 304, and 306 are shown for illustrative purpose to describe the features of the invention. Changes can be made to the design of the UI screens 302, 304, and 306, navigation among the UI screens 302, 304, and 306, fields included on the UI screens 302, 304, and 306, and the like, without deviating from the scope of the invention. In other embodiments, the customer device-based transaction may be initiated by way an interactive voice response (IVR) or a secure messaging service hosted by the issuer server 114. In another embodiment, the UI screen 306 may include additional text boxes (not shown), which require the customer 102 to enter the second identification information of the terminal device 106.

FIG. 4A is an exemplary scenario 400A that illustrates the terminal device 106, in accordance with an embodiment of the present invention. In this embodiment, the terminal device 106 is an ATM 106. The ATM 106 includes a display 402, a keypad 404, and a cash dispensing section (not shown). Additionally, the ATM 106 may include a card reader (not shown) to read transaction card details of transaction cards. In one embodiment, the ATM 106 may be RFID or NFC enabled for performing contactless transactions and cardless transactions. The ATM 106 enables the customer 102 to perform transactions from the customer account.

The display 402 displays a fourth UI screen 403 that presents a second set of transaction options (such as a customer device-based cash withdrawal option 406, a regular cash withdrawal option 408, a fast cash option 410, a deposit option 412, a statements option 414, and a balance enquiry option 416). The transaction options in the second set of transaction options are selectable by the customer 102. The keypad 404 is an encrypted pin pad (EPP) that includes a set of alpha-numeric keys (‘0’-‘9’, ‘F’, and ‘.’) and a set of function defined keys (FDKs) such as ‘Cancel’, ‘Clear’, and ‘Enter’.

The customer 102 selects the customer device-based cash withdrawal option 406 to perform the customer device-based transaction at the ATM 106. Once the customer 102 selects the customer device-based cash withdrawal option 406, the ATM 106 prompts the customer 102 to provide the first identification information (such as the registered mobile number or the registered e-mail id) linked to the customer account. The ATM 106 generates a broadcast message (i.e., the second request) that is broadcasted by way of the existing acquirer and payment network channel. In other words, the ATM 106 generates the broadcast message and communicates it to the acquirer server 110, which in turn communicates the broadcast message to the payment network server 112. The acquirer server 110 and the payment network server 112 correspond to the existing acquirer and payment network channel. The payment network server 112 then broadcasts the broadcast message through the communication network 116. The broadcast message includes the first identification information of the customer 102 linked to the customer account of the customer 102 and the second identification information of the ATM 106, such as the ATM ID.

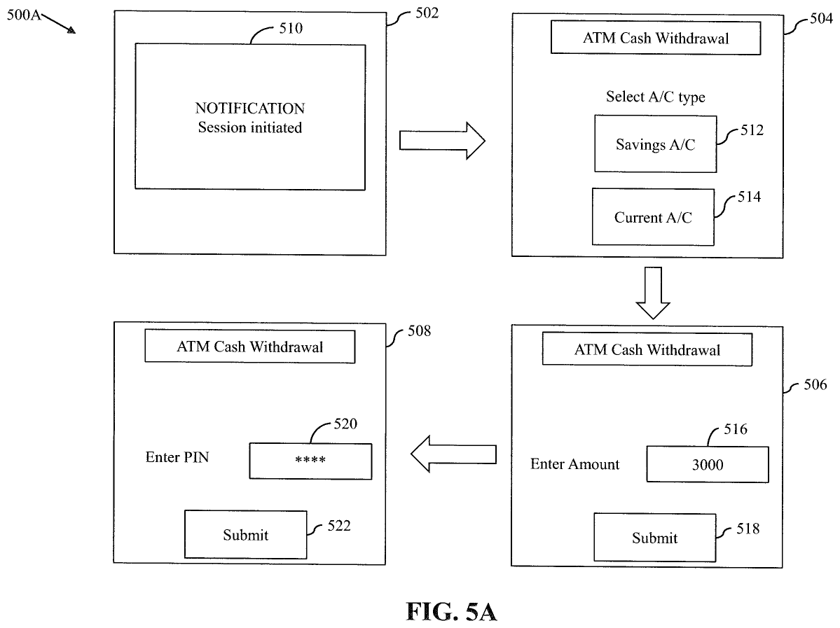

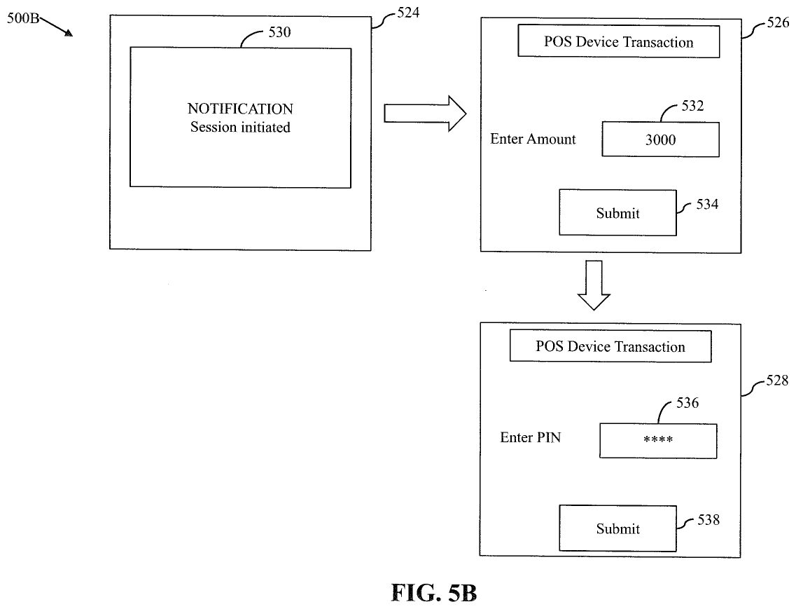

The issuer server 114 acknowledges the broadcast message if the broadcast message is received by the first transceiver 206 while being in the listening mode as explained in the foregoing description of FIG. 3. Other issuer servers (not shown) that may be present in the communication network 116 reject the broadcast message. The first authentication manager 210 verifies the first identification information of the customer 102 and the second identification information of the ATM 106. For verification, the first authentication manager 210 matches the first identification information received as part of the broadcast message with the first identification information of the customer 102 stored in the first memory 204. In other words, the first authentication manager 210 matches the mobile number of the customer 102 that is received as part of the broadcast message with the mobile number of the customer 102 that is stored in the first memory 204. The first authentication manager 210 further matches the ATM ID received in the broadcast message with various ATM IDs stored in the first memory 204. The first authentication manager 210 determines that the mobile number (i.e., the first identification information) and the ATM ID (i.e., the second identification information) are valid, when a successful match for the mobile number and the ATM ID is found. If the verification is successful, the first GUI emulation manager 212 creates a transaction session, which is valid for a second time-interval, on the customer device 104 as described later in conjunction with FIG. 5A. If the verification is unsuccessful, no transaction session is created on the customer device 104.

FIG. 4B is an exemplary scenario 400B that illustrates the terminal device 106, in accordance with an embodiment of the present invention. In this embodiment, the terminal device 106 is a POS device 106. The POS device 106 includes a display unit 418, a transaction card reader 420 to read transaction card details of transaction cards, a keypad 422, and an invoice printing section (not shown). In other embodiments, the transaction card reader 420 may be RFID or NFC enabled to read the transaction card of the customer 102 without being in contact with the transaction card. The POS device 106 enables the customer 102 to perform transactions from the customer device 104.

The display unit 418 displays a fifth UI screen 423 that presents a third set of transaction options (such as a customer device-based transaction option 424 and a card transaction option 426). The transaction options in the third set of transaction options are selectable by the customer 102. The keypad 422 is an EPP that includes a set of alpha-numeric keys (‘0’-‘9’, ‘F’, and ‘.’) and a set of function defined keys (FDKs) such as ‘Cancel’, ‘Clear’, ‘Enter’ ‘Options’, ‘Menu’, ‘Back’, and ‘Help’.

The customer 102 can select any transaction option from the third set of transaction options. To engage in a customer device-based transaction at the POS device 106 for making a payment to the merchant, the customer 102 selects the customer device-based transaction option 424. Once the customer 102 selects the customer device-based transaction option 424, the POS device 106 prompts the customer 102 to provide the first identification information (such as the registered mobile number or the registered e-mail id) linked to the customer account. The POS device 106 generates a broadcast message (i.e., the second request) that is broadcasted by way of the existing acquirer and payment network channel as described in FIG. 4A. The broadcast message includes the first identification information linked to the customer account of the customer 102 and the second identification information of the POS device 106, such as the unique POS device ID.

The issuer server 114 acknowledges the broadcast message, if the broadcast message is received by the first transceiver 206 while being in the listening mode as explained in the foregoing description of FIG. 3. Other issuer servers (not shown) reject the broadcast message. The first authentication manager 210 verifies the first and second identification information as explained in FIG. 4A. Upon successful verification of the first and second identification information, the first GUI emulation manager 212 creates a transaction session, which is valid for the second time-interval, on the customer device 104 as described later in conjunction with FIG. 5B.

FIG. 5A represents an exemplary scenario 500A that illustrates sixth through ninth UI screens 502, 504, 506, and 508 that are rendered on the customer device 104 for facilitating the customer device-based transaction, in accordance with an embodiment of the present invention. The UI screens 502, 504, 506, and 508, collectively, represent the payment interface of the ATM 106 (i.e., the terminal device 106) rendered by the issuer server 114 on the customer device 104, by way of the transaction application, during the transaction session. The initiation of the transaction session is explained in FIGS. 3 and 4A. The first GUI emulation manager 212 retrieves the set of instructions or the software code of the payment interface of the ATM 106 stored in the first memory 204 to render UI screens 502, 504, 506, and 508 on the customer device 104 during the transaction session. In other embodiments, the first GUI emulation manager 212 may retrieve the set of instructions or the software code of the payment interface of the ATM 106 directly from the acquirer server 110 to render the UI screens 502, 504, 506, and 508 on the customer device 104.

Upon the initiation of the transaction session on the customer device 104 by way of the transaction application, the customer 102 is redirected from the UI screen 306 to the UI screen 502. The UI screen 502 presents a first notification 510 to the customer 102 indicating that the transaction session is created. When the customer 102 acknowledges the first notification 510, the UI screen 504 is presented on the display of the customer device 104. The UI screen 504 replicates the functionality of the payment interface of the ATM 106 on the customer device 104 for withdrawing cash at the ATM 106. The UI screen 504 presents a message ‘Select A/c type’, thereby requesting the customer 102 to select the type of the customer account from which the customer 102 wants to perform the customer device-based transaction. Savings and current account options 512 and 514 represent two exemplary types of the customer account. The savings and current account options 512 and 514 are selectable by the customer 102.

The control is redirected to the UI screen 506, when the customer 102 selects one of the savings or current account option 512 or 514. The UI screen 506 presents a message ‘Enter Amount’, requesting the customer 102 to enter a transaction amount in a fourth text box 516 which is to be dispensed by the ATM 106. After entering the transaction amount, when the customer 102 selects a third submit button 518 on the UI screen 506, the control is redirected to the UI screen 508. The UI screen 508 presents a message ‘Enter PIN’, requesting the customer 102 to enter the PIN linked to the transaction card which the customer 102 wants to use for performing the customer device-based transaction. The UI screen 508 includes a fifth text box 520 for the customer 102 to enter the PIN, in addition to a fourth submit button 522 that is selectable by the customer 102.

When the customer 102 selects the fourth submit button 522 after entering the PIN, transaction details (i.e., the type of the account, the transaction amount, and the PIN) provided by the customer 102 are forwarded to the issuer server 114 in an encrypted format. The first transaction manager 214 validates the PIN provided by the customer 102 and checks if the customer account has sufficient funds to cover the transaction amount. On successful validation, the first transaction manager 214 processes the transaction. The steps involved in the processing of the transaction are known to those of skill in the art. A message (not shown) may be displayed on the customer device 104 and the ATM 106 indicating a success or a failure of the transaction. In one embodiment, if the transaction is successful, the ATM 106 dispenses cash equivalent to the transaction amount. In other embodiments, transactions other than cash withdrawal, such as ‘deposits’, may be performed.

After the creation of the transaction session on the customer device 104, the customer device 104 serves as the mode of entry for providing the transaction details. Since the transaction is initiated and performed at the ATM 106 based on the transaction details received through the customer device 104, it is understood that the customer device 104 and the ATM 106 has a logical connection therebetween. The logical connection may be defined by two communication channels, i.e., a first communication channel between the customer device 104 and the issuer server 114, and a second communication channel between the ATM 106 and the issuer server 114 by way of the acquirer server 110 and the payment network server 112.

FIG. 5B represents an exemplary scenario 500B that illustrates tenth through twelfth UI screens 524, 526, and 528 that are rendered on the customer device 104 for facilitating the customer device-based transaction, in accordance with an embodiment of the present invention. The UI screens 524, 526, and 528, collectively, represent the payment interface of the POS device 106 (i.e., the terminal device 106) rendered by the issuer server 114 on the customer device 104, by way of the transaction application, during the transaction session. The initiation of the transaction session is explained in FIGS. 3 and 4B. The first GUI emulation manager 212 retrieves the set of instructions or the software code of the payment interface of the POS device 106 stored in the first memory 204 to render the UI screens 524, 526, and 528 on the customer device 104 during the transaction session. In other embodiments, the first GUI emulation manager 212 may retrieve the set of instructions or the software code of the payment interface of the POS device 106 directly from the acquirer server 110 to render the UI screens 524, 526, and 528 on the customer device 104.

The customer 102 is redirected from the UI screen 306 to the UI screen 524 when the issuer server 114 creates the transaction session on the customer device 104 by way of the transaction application. The UI screen 524 presents a second notification 530 to the customer 102 indicating that the transaction session is created. When the customer 102 acknowledges the second notification 530, the UI screen 526 is presented on the display of the customer device 104. The UI screen 526 replicates the functionality of the payment interface of the POS device 106 on the customer device 104 for making the payment at the POS device 106. The UI screen 526 presents a message ‘Enter amount’, thereby requesting the customer 102 to enter the transaction amount, payable by the customer 102 to the merchant, in a sixth text box 532. The UI screen 526 includes a fifth submit button 534.

The control is redirected to the UI screen 528, when the customer 102 enters the transaction amount in the sixth text box 532 and selects the fifth submit button 534. The UI screen 528 presents a message ‘Enter PIN’, requesting the customer 102 to enter the PIN linked to the transaction card which the customer 102 wants to use for performing the transaction. The UI screen 528 includes a seventh text box 536 for the customer 102 to enter the PIN, in addition to a sixth submit button 538 that is selectable by the customer 102.

When the customer 102 selects the sixth submit button 538 after entering the PIN in the seventh text box 536, the transaction details (i.e., the transaction amount and the PIN) provided by the customer 102 are forwarded to the issuer server 114 in an encrypted format. The first transaction manager 214 validates the PIN provided by the customer 102 and checks if the customer account has sufficient funds to cover the transaction amount. On successful validation, the first transaction manager 214 processes the transaction and approves it. The steps involved in the processing of the transaction are known to those of skill in the art. A message (not shown) may be displayed on the customer device 104 and the POS device 106 indicating a success or a failure of the transaction. In one embodiment, if the transaction is successful, the transaction amount is transferred from the customer account to the merchant account, and the POS device 106 prints an invoice for the transaction.

During the transaction session, the customer device 104 serves as the mode of entry for providing the transaction details. Since the transaction is initiated and performed at the POS device 106 based on the transaction details received through the customer device 104, it is understood that a logical connection exists between the customer device 104 and the POS device 106. Such a logical connection may be defined by the first communication channel between the customer device 104 and the issuer server 114 and the second communication channel between the POS device 106 and the issuer server 114 by way of the existing acquirer and payment network channel.

For the sake of simplicity, FIGS. 3, 4A, 4B, 5A, and 5B are explained with respect to the issuer server 114 hosting the transaction application and facilitating the customer device-based transaction. In another embodiment, the payment network server 112 may host the transaction application and may perform the abovementioned functions of the issuer server 114 as explained in FIGS. 3, 4A, 4B, 5A, and 5B for facilitating the customer device-based transaction, without deviating from the scope of the invention.

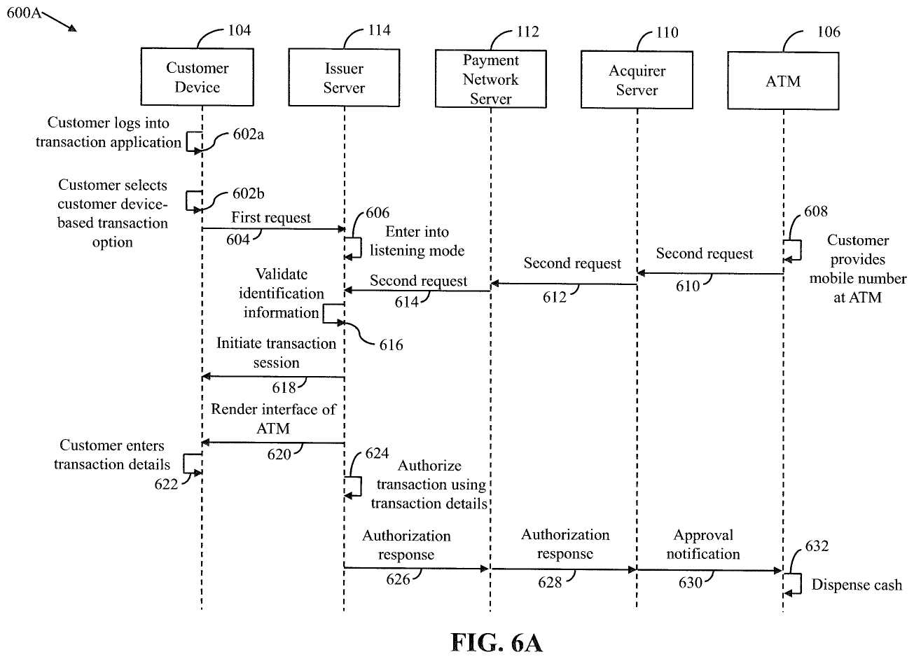

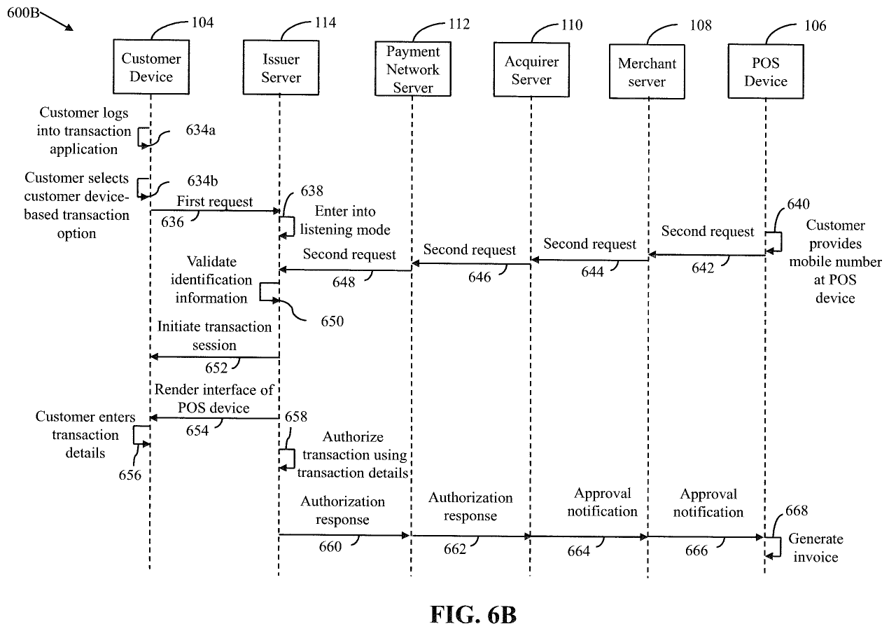

FIG. 6A is a process flow diagram 600A that illustrates an exemplary scenario for conducting a customer device-based transaction at the terminal device 106 by way of the customer device 104, in accordance with an embodiment of the present invention. For the sake of simplicity, it is assumed that the terminal device 106 is the ATM 106 and the exemplary scenario involves withdrawal of cash from the ATM 106 by performing the customer device-based transaction. The process flow diagram 600A involves the customer device 104, the ATM 106, the acquirer server 110, the payment network server 112, and the issuer server 114.

The customer 102 opens the transaction application of the issuer and enters the username and password for logging into the transaction application as described in FIG. 3 (as shown by arrow 602a). After successfully logging in, the customer 102 selects the ATM transaction option 318 (i.e., the customer device-based transaction option) presented on the UI screen 304 and provides the transaction card details of the transaction card that the customer 102 wishes to use for performing the customer device-based transaction at the ATM 106 (as shown by arrow 602b). Based on the selection of the ATM transaction option 318, the first request is generated by the transaction application and communicated to the issuer server 114 through the communication network 116 (as shown by arrow 604). The first request corresponds to a request for initiating the customer device-based transaction at the ATM 106 (such as the terminal device 106). The first request includes the transaction card details of the transaction card in an encrypted format. The first transceiver 206 receives the first request. Based on the first request, the issuer server 114 enters the listening mode for the first time-interval as described in the foregoing description of FIG. 3 (as shown by arrow 606).

The customer 102 accesses the UI screen 403 of the ATM 106 to select the customer device-based cash withdrawal option 406 and provides the first identification information (such as the registered mobile number or the e-mail ID) linked to the customer account at the ATM 106 (as shown by arrow 608). The ATM 106 generates a second request including the second identification information (i.e., the ATM ID) of the ATM 106 and the first identification information, and communicates the second request to the acquirer server 110 (as shown by arrow 610). The second request is the broadcasted message. The acquirer server 110 communicates the second request to the payment network server 112 (as shown by arrow 612) and the payment network server 112 further broadcasts the second request (as shown by arrow 614).

The first transceiver 206 receives the broadcasted second request, while being in the listening mode. In an alternate scenario, the first transceiver 206 may ignore the second request if the second request is received after the first time-interval. The first authentication manager 210 validates the second identification information (i.e., the ATM ID) of the ATM 106 and the first identification information of the customer 102 included in the second request (as shown by arrow 616). Based on the successful validation of the first and second identification information, the first GUI emulation manager 212 initiates the transaction session, that is valid for the second time-interval, on the customer device 104 (as shown by arrow 618) and renders the payment interface (i.e., the UI screens 502, 504, 506, and 508) of the ATM 106 on the customer device 104 (as shown by arrow 620). During the transaction session, the UI screens 502, 504, 506, and 508 enable the customer device 104 to serve as the mode of entry of all transaction details for the transaction.

The customer 102 enters the transaction details, such as the transaction amount and the PIN, by way of the rendered payment interface, i.e., the UI screens 502, 504, 506, and 508, (as shown by arrow 622). The transaction details, as provided by the customer 102, are received by the first transceiver 206. Based on the transaction details, the first transaction manager 214, in conjunction with the first authentication manager 210, authorizes the transaction (as shown by arrow 624) and debits the transaction amount from the customer account. The first transaction manager 214 communicates the authorization response to the payment network server 112 (as shown by arrow 626) and the payment network server 112 communicates the authorization response to the acquirer server 110 (as shown by arrow 628). Based on the authorization response, the acquirer server 110 transmits the approval notification to the ATM 106 (as shown by arrow 630), thereby authorizing the ATM 106 to dispense cash equivalent to the transaction amount (as shown by arrow 632).

FIG. 6B is a process flow diagram 600B that illustrates an exemplary scenario for conducting the customer device-based transaction at the terminal device 106 by way of the customer device 104, in accordance with another embodiment of the present invention. For the sake of simplicity, it is assumed that the terminal device 106 is the POS device 106 and the exemplary scenario involves making a payment at the POS device 106 by performing the customer device-based transaction. The process flow diagram 600B involves the customer device 104, the POS device 106, the merchant server 108, the acquirer server 110, the payment network server 112, and the issuer server 114.

The customer 102 opens the transaction application of the issuer and enters the username and password for logging into the transaction application as described in the foregoing description of FIG. 3 (as shown by arrow 634a). After successful login, the customer 102 selects the POS device transaction option 320 (i.e., the customer device-based transaction option) presented on the UI screen 304 and provides the transaction card details of the transaction card that the customer 102 wants to use for performing the customer device-based transaction at the POS device 106 (as shown by arrow 634b). Based on the selection of the POS device transaction option 320, the first request is generated by the transaction application and communicated to the issuer server 114 through the communication network 116 (as shown by arrow 636). The first transceiver 206 receives the first request and based on the first request, the issuer server 114 enters the listening mode for the first time-interval as described in the foregoing description of FIG. 3 (as shown by arrow 638).

The customer 102 accesses the UI screen 423 of the POS device 106 to select the customer device-based transaction option 424 and provides the first identification information (such as the registered mobile number) linked to the customer account (as shown by arrow 640). The POS device 106 generates the second request including the POS device ID (i.e., the second identification information) of the POS device 106 and the first identification information of the customer 102, and communicates the second request to the merchant server 108 (as shown by arrow 642). The merchant server 108 communicates the second request to the acquirer server 110 (as shown by arrow 644) and the acquirer server 110 further communicates the second request to the payment network server 112 (as shown by arrow 646). The payment network server 112 broadcasts the second request (as shown by arrow 648).

The first transceiver 206 receives the broadcasted second request while being in the listening mode. In an alternate scenario, the first transceiver 206 may ignore the second request if the second request is received after the first time-interval. The first authentication manager 210 validates the second identification information (i.e., the POS device ID) of the POS device 106 and the first identification information included in the second request (as shown by arrow 650). Upon successful validation, the first GUI emulation manager 212 initiates the transaction session, that is valid for the second time-interval, on the customer device 104 (as shown by arrow 652) and renders the payment interface (i.e., the UI screens 524, 526, and 528) of the POS device 106 on the customer device 104 (as shown by arrow 654). During the transaction session, the UI screens 524, 526, and 528 enable the customer device 104 to serve as the mode of entry of all transaction details for the transaction.

The customer 102 enters the transaction details, such as the transaction amount and the PIN, by way of the rendered payment interface, i.e., the UI screens 524, 526, and 528, (as shown by arrow 656). The transaction details, as provided by the customer 102, are received by the first transceiver 206 in an encrypted format. Based on the transaction details, the first transaction manager 214 authorizes the transaction (as shown by arrow 658) and debits the transaction amount from the customer account. The first transaction manager 214 communicates the authorization response to the payment network server 112 (as shown by arrow 660) and the payment network server 112 communicates the authorization response to the acquirer server 110 (as shown by arrow 662). Based on the authorization response, the acquirer server 110 credits the merchant account with the transaction amount and communicates the approval notification to the merchant server 108 (as shown by the arrow 664). The merchant server 108 communicates the approval notification to the POS device 106 (as shown by arrow 666), thereby authorizing the POS device 106 to generate and print an invoice for the transaction (as shown by arrow 668).

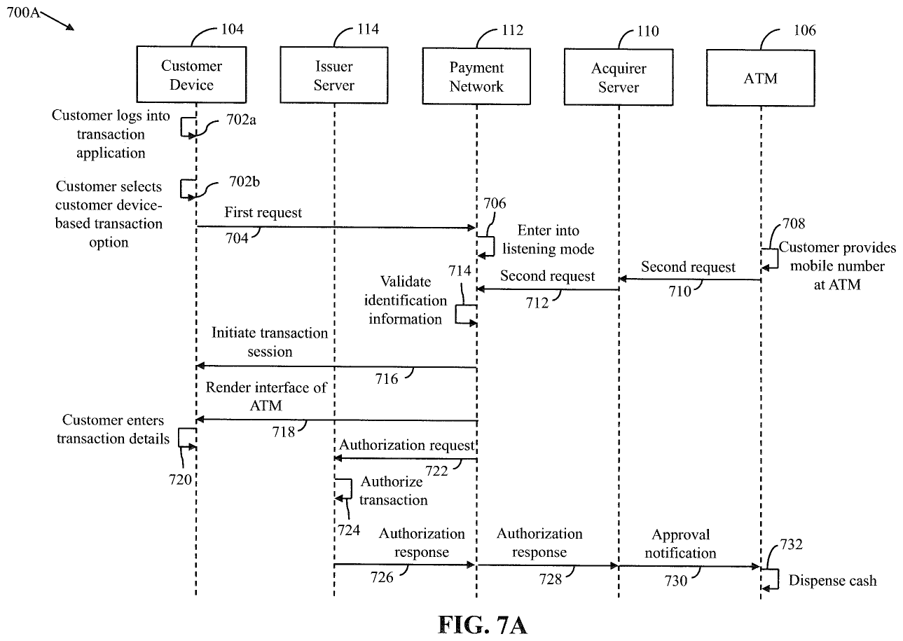

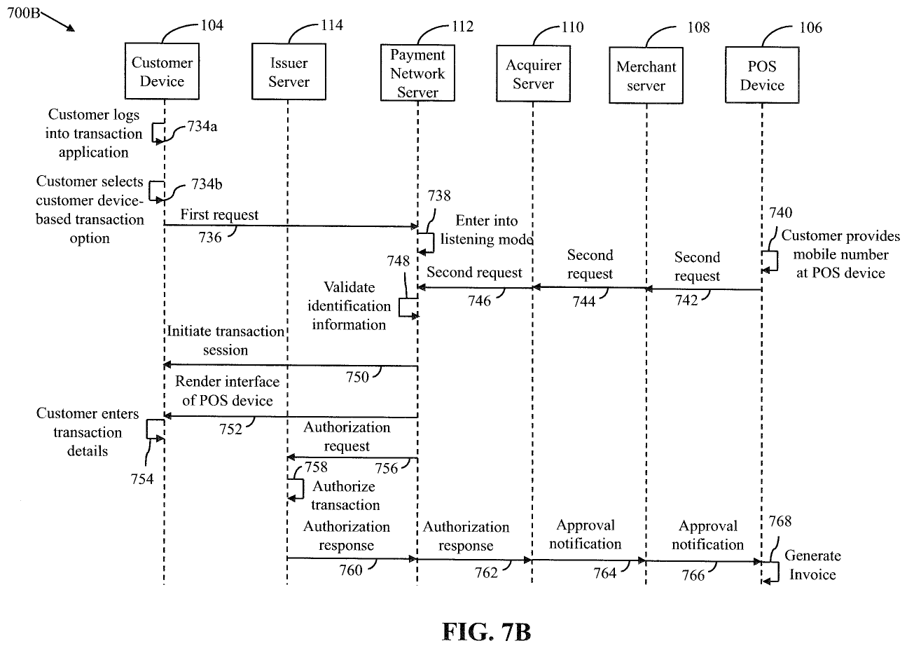

FIG. 7A is a process flow diagram 700A that illustrates an exemplary scenario for conducting the customer device-based transaction at the terminal device 106 by way of the customer device 104, in accordance with an embodiment of the present invention. For the sake of simplicity, it is assumed that the terminal device 106 is the ATM 106 and the exemplary scenario involves withdrawal of cash from the ATM 106 by performing the customer device-based transaction. The process flow diagram 700A involves the customer device 104, the ATM 106, the acquirer server 110, the payment network server 112, and the issuer server 114. The payment network server 112 may host the transaction application having an interface similar to the UI screens 302, 304, and 306 explained in the foregoing description of FIG. 3.

The customer 102 opens the transaction application of the payment network using the customer device 104 and enters the username and password for logging into the transaction application (as shown by arrow 702a). After successfully logging in, the customer 102 selects the ATM transaction option (i.e., the customer device-based transaction option) and provides the transaction card details of the transaction card that she wants to use for performing the customer device-based transaction at the ATM 106 (as shown by arrow 702b). Based on the selection of the customer device-based transaction option, the first request is generated by the transaction application and communicated to the payment network server 112 through the communication network 116 (as shown by arrow 704). The first request includes the transaction card details of the transaction card. The second transceiver 220 receives the first request and based on the first request, the payment network server 112 enters the listening mode for the first time-interval (as shown by arrow 706).

The customer 102 accesses the UI screen 403 of the ATM 106 to select the customer device-based cash withdrawal option 406 and provides the first identification information (such as the registered mobile number) linked to the customer account (as shown by arrow 708). The ATM 106 generates the second request including the second identification information (i.e., the ATM ID) of the ATM 106 and the first identification information, and communicates the second request to the acquirer server 110 (as shown by arrow 710). The second request is the broadcasted message. The acquirer server 110 broadcasts the second request (as shown by arrow 712).

The second transceiver 220 receives the second request while being in the listening mode. In an alternate scenario, the second transceiver 220 may ignore the second request if the second request is received after the first time-interval. The second authentication manager 224 validates the first and second identification information included in the second request (as shown by arrow 714). Upon successful validation, the second GUI emulation manager 226 initiates the transaction session, that is valid for the second time-interval, on the customer device 104 (as shown by arrow 716) and renders the payment interface (i.e., the UI screens 502, 504, 506, and 508) of the ATM 106 on the customer device 104 (as shown by arrow 718).

The customer 102 enters the transaction details, such as the transaction amount and the PIN, of the transaction by way of the rendered payment interface, i.e., the UI screens 502, 504, 506, and 508, (as shown by arrow 720). The transaction details are received by the second transceiver 220. The payment network server 112 transmits the authorization request including the transaction details to the issuer server 114, requesting authorization of the transaction (as shown by arrow 722). The authorization request is received by the first transceiver 206. Based on the transaction details in the authorization request, the first transaction manager 214, in conjunction with the first authentication manager 210, authorizes the transaction (as shown by arrow 724) and debits the transaction amount from the customer account. The first transaction manager 214 communicates the authorization response to the payment network server 112 (as shown by arrow 726) indicating the debit of the transaction amount and the payment network server 112 communicates the authorization response to the acquirer server 110 (as shown by arrow 728). Based on the authorization response, the acquirer server 110 transmits the approval notification to the ATM 106 (as shown by arrow 730), thereby authorizing the ATM 106 to dispense cash equivalent to the transaction amount (as shown by arrow 732).

FIG. 7B is a process flow diagram 700B that illustrates an exemplary scenario for conducting the customer device-based transaction at the terminal device 106 by way of the customer device 104, in accordance with another embodiment of the present invention. For the sake of simplicity, it is assumed that the terminal device 106 is the POS device 106 and the exemplary scenario involves a payment at the POS device 106 by performing the customer device-based transaction. The process flow diagram 700B involves the customer device 104, the POS device 106, the merchant server 108 the acquirer server 110, the payment network server 112, and the issuer server 114. The payment network server 112 may host the transaction application having the interface similar to the UI screens 302, 304, and 306 explained in the foregoing description of FIG. 3.

The customer 102 opens the transaction application of the payment network using the customer device 104 and enters the username and password for logging into the transaction application (as shown by arrow 734a). After successful login, the customer 102 selects the customer device-based transaction option and provides the transaction card details of the transaction card that she wants to use for performing the customer device-based transaction at the POS device 106 (as shown by arrow 734b). Based on the selection of the POS device transaction option 320 (i.e., the customer device-based transaction option), the first request is generated by the transaction application and communicated to the payment network server 112 through the communication network 116 (as shown by arrow 736). The first request includes the transaction card details of the transaction card. The second transceiver 220 receives the first request and based on the first request, the payment network server 112 enters the listening mode for the first time-interval (as shown by arrow 738).

The customer 102 accesses the UI screen 423 of the POS device 106 to select the customer device-based transaction option 424 and provides the first identification information (such as the registered mobile number) linked to the customer account (as shown by arrow 740). The POS device 106 generates the second request including the first and second identification information (i.e., the registered mobile number and the POS device ID, respectively) and communicates it to the merchant server 108 (as shown by arrow 742). The merchant server 108 communicates the second request to the acquirer server 110 (as shown by arrow 744). The second request is the broadcasted message. The acquirer server 110 broadcasts the second request (as shown by arrow 746).

The second transceiver 220 receives the second request while being in the listening mode. In an alternate scenario, the second transceiver 220 may ignore the second request if the second request is received after the first time-interval. The second authentication manager 224 validates the POS device ID (i.e., the second identification information) of the POS device 106 and the registered mobile number included in the second request (as shown by arrow 748). Based on successful validation, the second GUI emulation manager 226 initiates the transaction session, that is valid for the second time-interval, on the customer device 104 (as shown by arrow 750) and renders the payment interface (i.e., the UI screens 524, 526, and 528) of the POS device 106 on the customer device 104 (as shown by arrow 752).

The customer 102 enters the transaction details, such as the transaction amount and the PIN, by way of the rendered payment interface, i.e., the UI screens 524, 526, and 528, (as shown by arrow 754). The transaction details are received by the second transceiver 220. The payment network server 112 transmits the authorization request including the transaction details to the issuer server 114, requesting authorization of the transaction (as shown by arrow 756). The authorization request is received by the first transceiver 206. Based on the authorization request, the first transaction manager 214, in conjunction with the first authentication manager 210, authorizes the transaction (as shown by arrow 758) and debits the transaction amount from the customer account. The first transaction manager 214 communicates the authorization response to the payment network server 112 (as shown by arrow 760) and the payment network server 112 communicates the authorization response to the acquirer server 110 (as shown by arrow 762). Based on the authorization response, the acquirer server 110 credits the merchant account of the merchant associated with the POS device 106 with the transaction amount and transmits the approval notification to the merchant server 108 (as shown by the arrow 764). The merchant server 108 communicates the approval notification to the POS device 106 (as shown by arrow 766), thereby authorizing the POS device 106 to generate an invoice for the transaction (as shown by arrow 768).

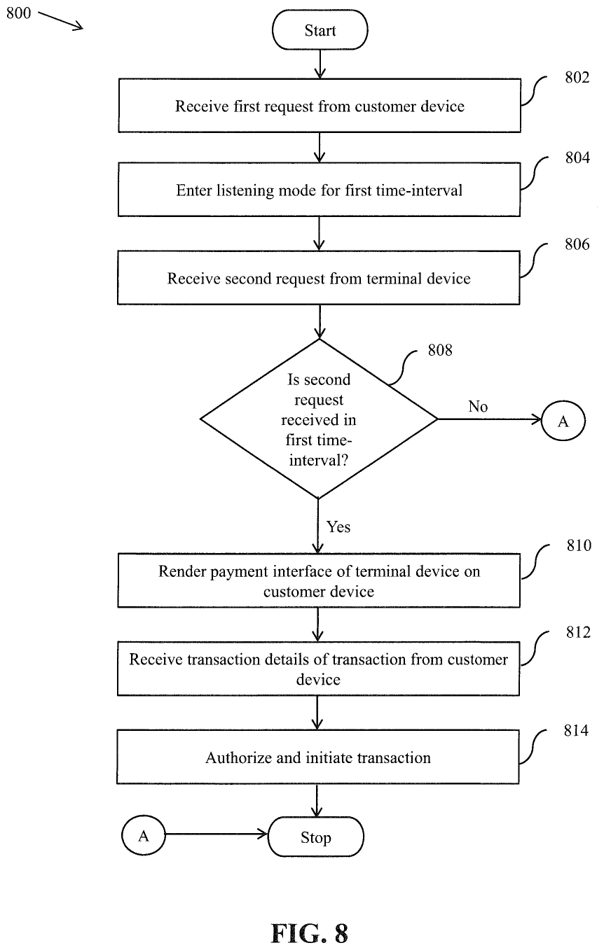

FIG. 8 represents a flow chart 800 that illustrates a method for conducting the customer device-based transaction at the terminal device 106, in accordance with an embodiment of the present invention. For the sake of simplicity, the flow chart 800 is explained with respect to the issuer server 114 hosting the transaction application. However, in another embodiment, the payment network server 112 hosts the transaction application and performs the method illustrated by the flow chart 800, without deviating from the scope of the invention.

The customer 102 logs into the transaction application of the issuer server 114 and selects the customer device-based transaction option. Based on the selection of the customer device-based transaction option, the first request is generated by the transaction application and communicated to the issuer server 114 through the communication network 116. At step 802, the issuer server 114 receives the first request from the customer device 104. At step 804, the issuer server 114 enters the listening mode, for the first time-interval, based on the reception of the first request. At step 806, the issuer server 114 receives, from the terminal device 106, the second request that includes the first and second identification information of the customer 102 and the terminal device 106, respectively. At step 808, the issuer server 114 checks if the second request was received within the first time-interval. If at step 808, it is determined that the second request was not received within the first time-interval, the issuer server 114 ignores the second request. If at step 808, it is determined that the second request was received within the first time-interval, the issuer server 114 acknowledges the second request and performs step 810.

At step 810, the issuer server 114 initiates a transaction session and renders the GUI of the terminal device 106 on the customer device 104 during the transaction session. The rendered GUI replicates the functionality of the terminal device 106 on the customer device 104, thereby enabling the customer device 104 to function as the mode of entry of the transaction details of the transaction. The customer provides the transaction details of the transaction by using the rendered GUI. At step 812, the issuer server 114 receives the transaction details, as provided by the customer 102 using the GUI, from the customer device 104. At step 814, the issuer server 114 authorizes and initiates the transaction at the terminal device 106 based on the transaction details of the transaction.

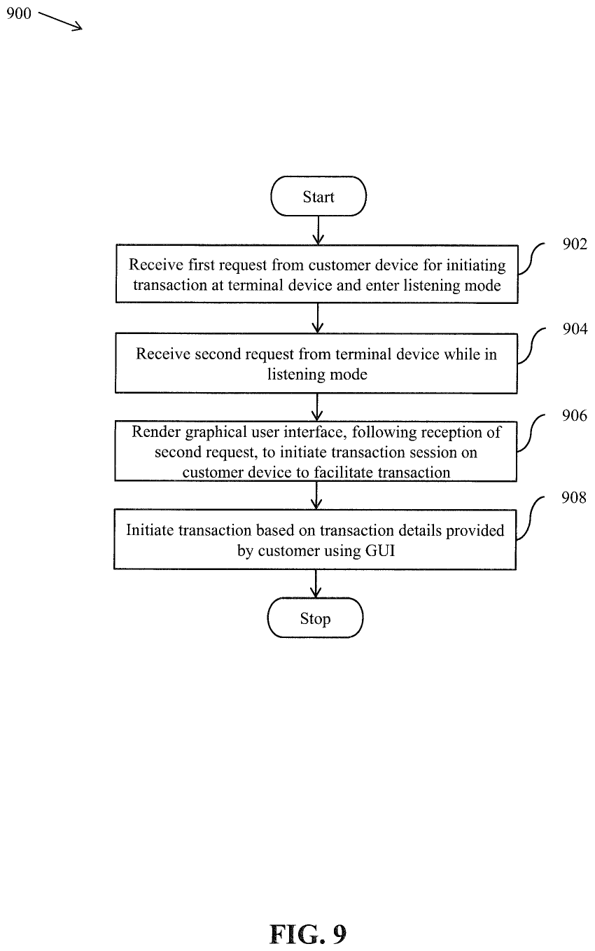

FIG. 9 represents a high-level flow chart 900 that illustrates the method for conducting the customer device-based transaction at the terminal device 106, in accordance with an embodiment of the present invention. The customer 102 logs into the transaction application of a server (i.e., the payment network server 112 or the issuer server 114) and selects the customer device-based transaction option. Based on the selection of the customer device-based transaction option, the first request is generated by the transaction application and communicated to the server through the communication network 116. At step 902, the server receives the first request and enters the listening mode for the first time-interval. At step 904, the server receives the second request from the terminal device 106. The second request includes first and second identification information of the customer 102 and the terminal device 106, respectively. At step 906, the server renders the GUI, following on the customer device 104, to initiate the transaction session on the customer device 104 for facilitating the transaction. The GUI replicates the functionality of the payment interface of the terminal device 106 on the customer device 104. At step 908, the server initiates the transaction based on the transaction details provided by the customer 102 using the GUI.

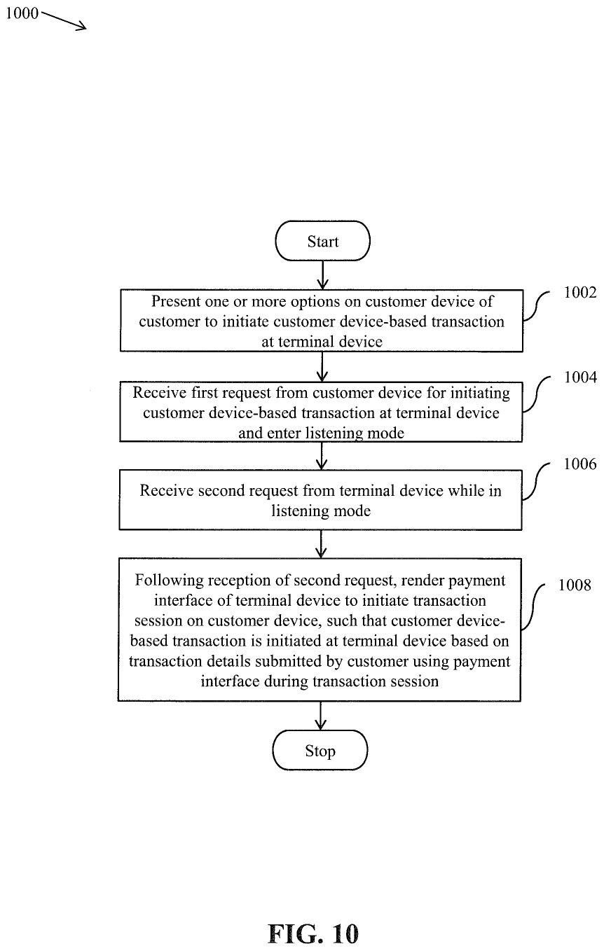

FIG. 10 represents a high-level flow chart 1000 that illustrates the method for conducting the customer device-based transaction at the terminal device 106, in accordance with another embodiment of the present invention.

At step 1002, a server (such as the payment network server 112 or the issuer server 114) presents one or more options on the customer device 104 to initiate the customer device-based transaction at the terminal device 106. The one or more options are selectable by the customer 102. At step 1004, the server receives the first request from the customer device 104 for initiating the customer device-based transaction at the terminal device 106. The server enters the listening mode for the first time-interval. At step 1006, the server receives the second request from the terminal device 106, while the server is in the listening mode. The second request includes the first and second identification information of the customer 102 and the terminal device 106, respectively. At step 1008, following the reception of the second request, the server renders the payment interface of the terminal device 106 to initiate a transaction session on the customer device 104, such that the customer device-based transaction is initiated at the terminal device 106 based on the transaction details submitted by the customer 102 using the payment interface during the transaction session.

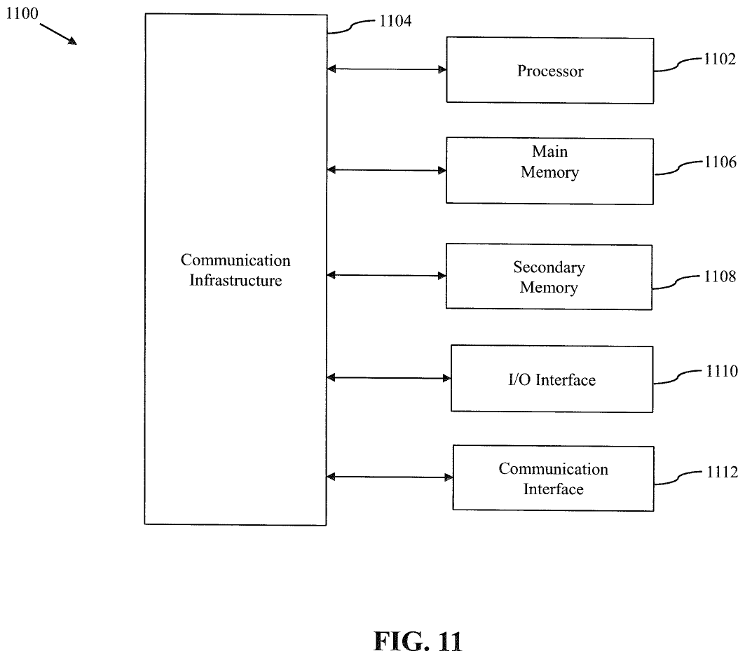

FIG.11 is a block diagram that illustrates system architecture of a computer system 1100, in accordance with an embodiment of the present invention. An embodiment of present invention, or portions thereof, may be implemented as computer readable code on the computer system 1100. In one example, the customer device 104, the terminal device 106, the merchant server 108, the acquirer server 110, the payment network server 112, and the issuer server 114 of FIG. 1 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 8, 9, and 10.

The computer system 1100 includes a processor 1102 that may be a special-purpose or a general-purpose processing device. The processor 1102 may be a single processor, multiple processors, or combinations thereof. The processor 1102 may have one or more processor cores. In one example, the processor 1102 is an octa-core processor. Further, the processor 1102 may be connected to a communication infrastructure 1104, such as a bus, message queue, multi-core message-passing scheme, and the like. The computer system 1100 may further include a main memory 1106 and a secondary memory 1108. Examples of the main memory 1106 may include RAM, ROM, and the like. In one embodiment, the main memory 1106 is one of the first memory 204 or the second memory 218. The secondary memory 1108 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1100 further includes an input/output (I/O) interface 1110 and a communication interface 1112. The I/O interface 1110 includes various input and output devices that are configured to communicate with the processor 1102. Examples of the input devices may include a keyboard, a mouse, a joystick, a touchscreen, a microphone, and the like. Examples of the output devices may include a display screen, a speaker, headphones, and the like. The communication interface 1112 may be configured to allow data to be transferred between the computer system 1100 and various devices that are communicatively coupled to the computer system 1100. Examples of the communication interface 1112 may include a modem, a network interface, i.e., an Ethernet card, a communication port, and the like. Data transferred via the communication interface 1112 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 1100. Examples of the communication channel may include, but are not limited to, cable, fiber optics, a phone line, a cellular phone link, a radio frequency link, and the like.

Computer program medium and computer usable medium may refer to memories, such as the main memory 1106 and the secondary memory 1108, which may be a semiconductor memory such as a DRAM. These computer program mediums may provide data that enables the computer system 1100 to implement the methods illustrated in FIGS. 8, 9, and 10. In an embodiment, the present invention is implemented using a computer implemented application, the computer implemented application may be stored in a computer program product and loaded into the computer system 1100 using the removable storage drive or the hard disc drive in the secondary memory 1108, the I/O interface 1110, or the communication interface 1112.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded in virtually any device. For instance, at least one processor such as the processor 1102 and a memory such as the main memory 1106 and the secondary memory 1108 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

The invention offers advantages to both customers and acquirers. Owing to the ubiquity of mobile phones, the invention offers an acquirer the choice to install terminal devices (such as ATMs and POS devices) with minimum hardware, and with the means to receive customer identification, typically a mobile number. The acquirer may choose to install the terminal devices without displays considering that the interface of the terminal devices is replicated on the customer devices, resulting in installation of the terminal devices with smaller footprints. This leads to reduction of hardware required for the installation of the terminal devices, resulting in financial benefits for the acquirer. Much of the failure-prone hardware, such as EPPs, FDKs, displays, and the like, installed in the terminal devices will be redundant as the transaction is enabled by a terminal device interface replicated on the customer device, such as the customer device 104. Thus, the acquirer's hardware maintenance costs are reduced, and operating costs, for the acquirer, are subject to the release of software upgrades of terminal device mapping interfaces.

Customers in possession of mobile phones enjoy several advantages in regards to the invention. The rendering of the GUIs of the terminal devices on customer devices allow the customers to drive the transaction, resulting in a secure and a fool proof experience. A transaction conducted by means of the method and system of the present invention is, essentially, isolated from the hardware of the terminal device 106, and is conducted from secure location i.e., the customer device 104. Therefore, risks of fraud by skimmers, at ATMs, and by merchants, at POS devices, are mitigated. Customers are also relieved of the need to deal with faulty hardware at the terminal device 106, allowing for a convenient and a hassle-free experience.

Techniques consistent with the present invention provide, among other features, systems and methods for conducting customer device-based transactions at terminal devices. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A method for conducting transactions, the method comprising:
receiving, by a server from a customer device of a customer, a first request to initiate a transaction at a terminal device by using the customer device, wherein the server enters a listening mode based on the first request;
receiving, by the server in the listening mode, a second request from the terminal device, wherein the second request includes at least first identification information of the customer and second identification information of the terminal device;
rendering, by the server, a graphical user interface (GUI) of the terminal device, following the reception of the second request, to initiate a transaction session on the customer device for facilitating the transaction; and
initiating, by the server, the transaction at the terminal device based on transaction details submitted by the customer using the GUI during the transaction session.

2. The method of claim 1, wherein the terminal device is a point-of-sale (POS) device, and wherein the GUI replicates a functionality of the POS device on the customer device.

3. The method of claim 1, wherein the terminal device is an automated teller machine (ATM), and wherein the GUI replicates a functionality of the ATM on the customer device.

4. The method of claim 1, further comprising storing, by the server, third identification information of the customer in a memory associated with the server during a registration of the customer.

5. The method of claim 4, further comprising verifying, by the server, the first identification information based on a match with the third identification information, wherein the rendering of the GUI is subject to the verification of the first identification information.

6. The method of claim 1, further comprising verifying, by the server, the second identification information, wherein the rendering of the GUI is subject to the verification of the second identification information.

7. The method of claim 1, wherein the server enters the listening mode for a first time-interval based on the first request, and wherein the server renders the GUI on the customer device when the second request is received within the first time-interval.

8. The method of claim 1, further comprising presenting, by the server on the customer device, one or more options to initiate the transaction at the terminal device by way of the customer device, wherein the one or more options are selectable by the customer, and wherein the first request is received by the server when the customer selects one of the one or more options.

9. A system for conducting transactions, the system comprising:
a server comprising circuitry configured to:
receive, from a customer device of a customer, a first request to initiate a transaction at a terminal device by using the customer device, wherein the server enters a listening mode based on the first request;
receive, while the server is in the listening mode, a second request from the terminal device, wherein the second request includes at least first identification information of the customer and second identification information of the terminal device;
render a graphical user interface (GUI) of the terminal device, following the reception of the second request, to initiate a transaction session on the customer device for facilitating the transaction; and
initiate the transaction at the terminal device based on transaction details submitted by the customer using the GUI during the transaction session.

10. The system of claim 9, wherein the terminal device is a point-of-sale (POS) device, and wherein the GUI replicates a functionality of the POS device on the customer device.

11. The system of claim 9, wherein the terminal device is an automated teller machine (ATM), and wherein the GUI replicates a functionality of the ATM on the customer device.

12. The system of claim 9, wherein the circuitry is further configured to:
store third identification information of the customer in a memory associated with the server during a registration of the customer.

13. The system of claim 12, wherein the circuitry is further configured to:
verify the first identification information based on a match with the third identification information, and wherein the rendering of the GUI is subject to the verification of the first identification information.

14. The system of claim 9, wherein the circuitry is further configured to:
verify the second identification information, and wherein the rendering of the GUI is subject to the verification of the second identification information.

15. The system of claim 9, wherein the server enters the listening mode for a first time-interval based on the first request, and wherein the circuitry is configured to render the GUI on the customer device when the second request is received within the first time-interval.

16. The system of claim 9, wherein the circuitry is further configured to:
present, on the customer device, one or more options to initiate the transaction at the terminal device by way of the customer device, wherein the one or more options are selectable by the customer, and wherein the first request is received by the server when the customer selects one of the one or more options.

17. A method for conducting transactions, the method comprising:
presenting, by a server on a customer device of a customer, one or more options to initiate a customer device-based transaction at a terminal device, wherein the one or more options are selectable by the customer;
receiving, by the server from the customer device, a first request to initiate the customer device-based transaction at the terminal device, when the customer selects one of the one or more options, wherein the server enters a listening mode based on the first request;
receiving, by the server in the listening mode, a second request from the terminal device, wherein the second request includes at least first identification information of the customer and second identification information of the terminal device; and
rendering, by the server, a payment interface of the terminal device, following the reception of the second request, to initiate a transaction session on the customer device, such that the customer device-based transaction is initiated at the terminal device based on transaction details submitted by the customer using the payment interface during the transaction session.

18. The method of claim 17, wherein the terminal device is a point-of-sale (POS) device wherein the payment interface replicates a functionality of the POS device on the customer device.

19. The method of claim 17, wherein the terminal device is an automated teller machine (ATM) and wherein the payment interface replicates a functionality of the ATM on the customer device.

20. The method of claim 17, further comprising verifying, by the server, the first and second identification information, wherein the rendering of the payment interface is subject to the verification of the first and second identification information.
